(19) United States
(12) Patent Application Publication
(10) Pub. No.: US 2018/0052850 A1
(43) Pub. Date: Feb. 22, 2018

(54) PERSONALIZED MESSAGE DELIVERY SYSTEM

(71) Applicant: LinkedIn Corporation, Mountain View, CA (US)

(72) Inventors: Shaunak Chatterjee, Sunnyvale, CA (US); Hsiao-Ping Tseng, Fremont, CA (US); Xiaoyu Chen, Sunnyvale, CA (US)

(21) Appl. No.: 15/240,826

(22) Filed: Aug. 18, 2016

(51) Int. Cl. G06F 17/30; H04L 12/58; G06Q 50/00

(52) U.S. Cl. CPC G06F 17/3053; G06Q 50/01; G06F 17/30312; H04L 51/32

(57) ABSTRACT

Techniques for a message generator are described. An event database can store a plurality of connection updates. Each connection update in the plurality of connection updates can be associated with a category from a set of categories. A member database can store member data of a first recipient. A message generator can determine a first group from a plurality of groups based on the member data of the first recipient, and can determine a first category from the set of categories based on the determined first group. Additionally, a relevance score can be calculated for each connection update associated with the determined first category. Furthermore, a first connection update can be selected from the plurality of connection updates based on the calculated relevance score for each connection update. Subsequently, a message can be generated based on the selected first connection update.

### TECHNICAL FIELD

The subject matter disclosed herein relates generally to the technical field of data processing and specifically to storing and processing connection updates for a personalized message to a member that is associated with a selected event update.

### BACKGROUND

An online social network can maintain information on members, companies, organizations, employees, and employers. The online social network may maintain profile pages of members, which can include education information and employment information about a specific member. The educational information and employment information can be listed in a resume format in the profile page that can be viewed by scrolling the profile page to view all of the information. Additionally, a message, such as an email, can be sent to a member of the online social network. In some instances, information relevant to the member may not be included in the message that is sent to the member.

### BRIEF DESCRIPTION OF THE DRAWINGS

Some embodiments are illustrated by way of example and not limitation in the figures of the accompanying drawings.

FIG. 1 is a network diagram illustrating a network environment suitable for an online social network, according to some example embodiments.

FIG. 2 is a block diagram illustrating various components of an online social network, according to some example embodiments.

FIG. 3 is a flowchart illustrating a method for generating a personalized message for a member of the online social network, according to some example embodiments.

FIG. 4 is a flowchart illustrating a method for calculating a relevance score for a member update, according to some example embodiments.

FIG. 5 is a user interface diagram illustrating personalized messages for a first recipient and a second recipient, according to some embodiments.

FIG. 6 is a block diagram illustrating components of a machine, according to some example embodiments, able to read instructions from a machine-readable medium and perform any one or more of the methodologies discussed herein.

### DETAILED DESCRIPTION

The description that follows includes systems, methods, techniques, instruction sequences, and computing machine program products that embody illustrative embodiments. In the following description, for the purposes of explanation, numerous specific details are set forth in order to provide an understanding of various embodiments of the subject matter discussed herein. It will be evident, however, to those skilled in the art, that embodiments of the inventive subject matter may be practiced without these specific details. In general, well-known instruction instances, protocols, structures, and techniques are not necessarily shown in detail.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident, to one skilled in the art, however, that the present subject matter may be practiced without these specific details.

In conventional implementations, the subject line of an automated email is predetermined for all of the members of the online social network. For example, a couple different variations (e.g., “You have a new invitation from John Doe” vs. “John has just sent you an invitation”) of the subject line of the automated email are used during a testing stage. Subsequently, a determination is made to select a preferred subject line from the couple different variations. Then the preferred email is sent to all of the members of the online social network. The testing is performed at a global level, and the better-performing subject line is sent to all the members.

In contrast, according to some embodiments of the present disclosure, the online social network includes a message generator that generates a message (e.g., email) with a personalized subject line that is tailored for each recipient of the email. The subject line for the same type of email can be personalized based on the information associated with the recipient of the email. For example, a first recipient and a second recipient can receive a connection request from a first member. The subject line of the email associated with the connection request can be different based similarities between the first recipient and the first member, and based on similarities between the second recipient and the first member. The message generator can determine that the first recipient is a work colleague of the first member, while the second recipient is a classmate of the first member. Subsequently, the message generator can personalize the subject line of the connection request to the first recipient to highlight that the first member is a work colleague, and personalize the subject line of the connection request to the second recipient to highlight that the first member is a classmate. In some instances, the email is personalized based on connection updates associated with the recipient's first-degree connections. Accordingly, as described herein, each message can be personalized and tailored to each individual member of the online social network.

For example, the message generator generates and sends a first message, such as an email, to a first recipient associated with connections updates of the first recipient. Additionally, the message generator can generate and send a second message to a second recipient associated with connection updates of the second recipient. The connection updates of the first recipient include, but are not limited to, changes in the profile data of the first-degree connections of the first recipient, recent activities of the first-degree connections of the first recipient, and so on. Similarly, the connection updates of the second recipient include, but are not limited to, changes in the profile data of the first-degree connections of the second recipient, recent activities of the first-degree connections of the second recipient, and so on. Alternatively, the connection updates can be based on updates of the second-degree connections and third-degree connections of the recipient (e.g., first recipient, second recipient).

The connection updates associated with changes in the profile data of a connection include a job change of the connection (e.g., the connection started a new job, the connection left a current employer), a location change of the connection (e.g., the connection moved to a new city), an educational change of the connection (e.g., the connection obtained a new degree or certification), and other changes to the profile data of the connection. The connection updates associated with recent activities of a connection include a publication posted by the connection, a work anniversary of the connection, and so on. As previously mentioned, a first-degree connection of the member in the online social network is an example of a connection.

In some instances, a weekly digest of connection updates can be sent to the first recipient once a week. The message generator selects the connection updates and generates a message based on the selected connection updates. The connection updates can be selected based on a relevance score to the recipient. As later described, the relevance score is calculated based on the member data of the recipient. The recipient is a member of the online social network, and the member data includes profile data, social graph data, and activity data.

According to some embodiments, the message generator categorizes each recipient into a group (e.g., first group, second group, and so on) based on the member data of each recipient. Subsequently, the message generator selects a connection update category (e.g., job change, profile page change, publication posting) for each group. For example, a connection update associated with a job change is sent to the first group. The connection update category can be selected based on activity data (e.g., click-through rate, message open rate) of the members of each group. The connection update category includes a plurality of connection updates. Then, a relevance score for each connection update in the selected connection update category is calculated. Subsequently, a message is generated by the message generator based on the calculated relevance scores. For example, a message can be generated using a first connection update, the first connection update having the highest relevance score. In some instances, the subject line of the message can include information associated with the first connection update.

Moreover, a different connection update category can be selected for a second group. Different messages are sent to the different groups based on the selected connection update category. For example, a first message associated with a job change is sent to a first group, a second message associated with a profile page change is sent to a second group, a third message associated with a publication posting is sent to a third group, and so on. Furthermore, the connection updates sent to the different members in the first group can differ based on the relevance score calculated for each connection update.

The message generator determines when a recipient interacts with the content in the message. For example, the recipient can open the message, click on a link in the message, reply to the message, share content in the message on an online social media service, and so on. The message generator can capture the interactions by the recipient, and store the interactions as activity data. Additionally, the message generator can update the relevance score for future updates based on the activity data of the recipient.

Using machine-learning algorithms, the message generator can update the relevance score and the selection of the connection update in the personalized message based on the activity data (e.g., click-through rate, message open rate) of the recipients. For example, when a recipient interacts with (e.g., replies to, clicks on a link embedded in, opens) a received message, then the relevance score associated with the connection update in the message is increased. Subsequently, the next message sent can be based on updated relevance scores. In some instances, the click-through rate and the message open rate are inputs to the model associated with the machine-learning algorithms. Based on these inputs, the model receives feedback from the recipient of the personalized message, and accordingly updates the coefficient (e.g., multiplier) associated with each input used for calculating the relevance score. For example, when the machine learning algorithms determine that the recipient is more likely than previously determined to open a message when the connection update is related to a coworker, then the coefficient associated with a connection update that is related to a coworker is increased. The inputs to the machine-learning algorithms can be received using feedback (e.g., click-through rate, open rate) from each group in the plurality of groups (e.g., recruiters, sales team, software developers). As a result, the algorithms of calculating a relevance score can vary for each group. The different machine learning techniques can include association rule learning, neural network, inductive logic programming, clustering, support vector machines, reinforcement learning, similarity learning, and so on.

Furthermore, a user interface allows recipients to customize the type of messages received from the message generator. For example, a member may decide to not receive updates associated with certain category types (e.g., work anniversary). Accordingly, the message generator can send messages to the recipient based on the customized request of the recipient. The message generator can push a notification (e.g., instant message in the online social network platform) to the members of the online social network. Furthermore, the method of pushing the notifications can be tailored to each recipient based on the activity data of the recipient.

In some instances, recipients can grow a resistance to a similar message (e.g., email) sent on a periodic basis (e.g., weekly). The message generator changes the variant of the subject line and the content of the message that is sent on a periodic basis in order to overcome such resistance. The selected variant for a recipient can be based on the delivery time, previous messages sent to the recipient, and the interactions (e.g., member activity) of the recipient with the previous messages. For example, even when the connection updates are similar between the messages, the subject line can differ between the messages. The subject line can be broken up into three components, which include an actor, a verb, and an object. Thus, even when the connection updates contained in the messages are similar between messages, the actor, verb, and object in the subject line of the messages can be different. The variant of the subject line can be changed using machine-learning algorithms based on the recipient's interaction with a previous message. In some instances, the machine-learning algorithms can be processed offline.

In an example embodiment, the message generator sends a weekly email to a recipient regarding updates associated with the first-degree connections of the recipient. The message generator can first select a content type based on a relevance score, then select one of multiple variants for the content type. The content types for an update can include a job change of a first-degree connection, a profile page change of a first-degree connection, a post by a first-degree connection, a publication by an influencer, a publication by an organization, a work anniversary of a first-degree connection, and so on. The influencer and organization can be entities that are followed by the recipient, as later described herein. The message generator selects a content type for the recipient based on a relevance score. Once the content type is selected, the message generator generates an email that includes an update with the selected content type. Additionally, the email is generated by selecting a personalized subject line from a plurality of subject lines, each subject line in the plurality of subject lines having a variant with the description of the update. Furthermore, the subject line of the email can be varied from week to week by selecting another subject line from the plurality of subject lines.

Techniques described herein allow for a message generator to generate a message based on the profile data, social graph data, and activity data of the recipient of the message. Additionally, the message generator can determine the updates that are relevant to the recipient based on a relevance score. In some instances, in order to increase the speed of the process, the relevance score can be calculated offline or by special-purpose computers using custom-tailored databases. The custom-tailored databases can capture activity data (e.g., click-through-rate, message open rate) of the recipient in an efficient manner in order to calculate the relevance score in real time. The message generator can generate the message in real time based on a plurality of databases storing updates, activity data of the recipient, and employment information of members.

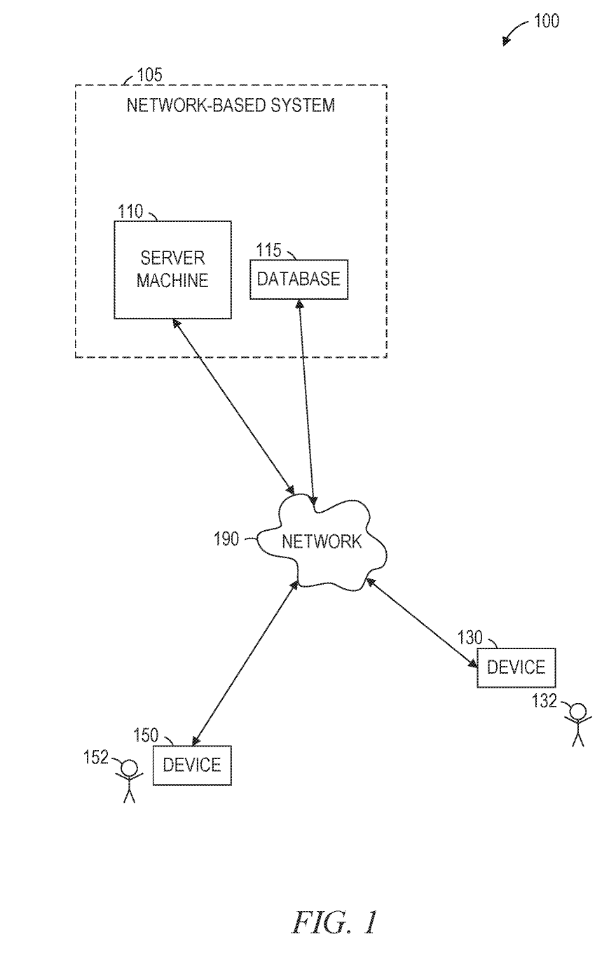

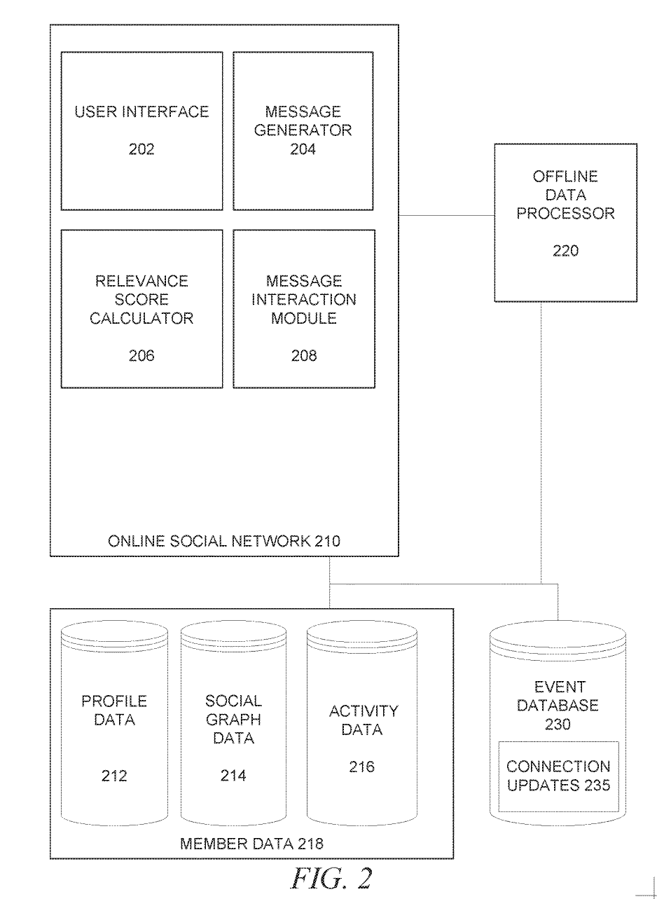

FIG. 1 is a network diagram illustrating a network environment 100 suitable for an online social network service, according to some example embodiments. The network environment 100 includes a server machine 110, a database 115, a first device 130 for a first user 132, and a second device 150 for a second user 152, all communicatively coupled to each other via a network 190. The server machine 110 and the database 115 may form all or part of a network-based system 105 (e.g., a cloud-based server system configured to provide one or more services to the devices 130 and 150). The online social network later illustrated in FIG. 2 is an example of the server machine 110. Additionally, the member data and the connection updates later illustrated in FIG. 2 can be stored in the database 115.

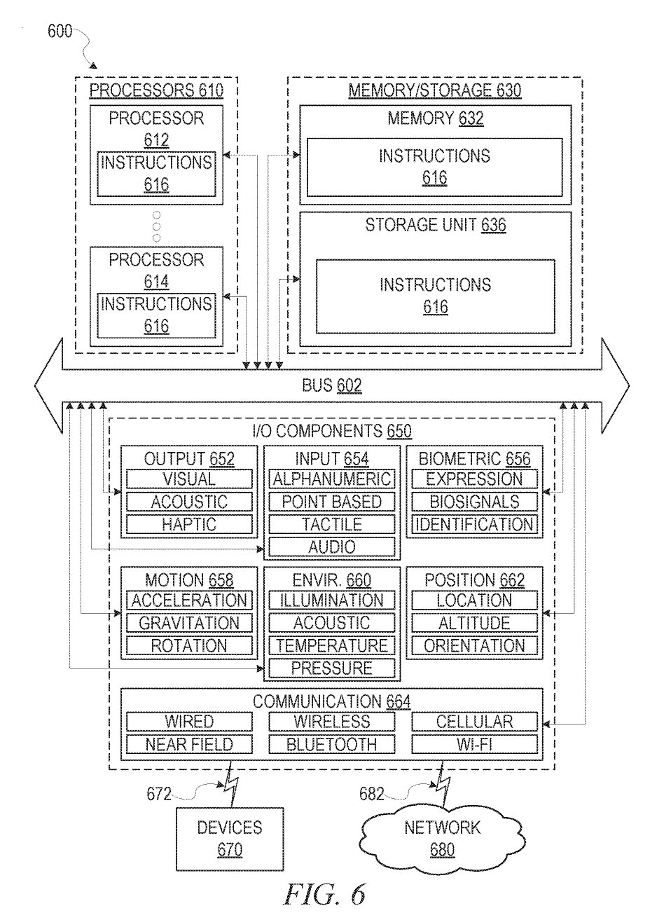

The database 115 can store, but is not limited to storing, member data, company data, education data, social graph data, and activity data for the online social network service. In some instances, the database 115 can include a plurality of databases (e.g., a first database to store profile data, a second database to store social data, and a third database to store member activity data). The server machine 110, the first device 130, and the second device 150 may each be implemented in a computer system, in whole or in part, as described below with respect to FIG. 6.

Also shown in FIG. 1 are the users 132 and 152. One or both of the users 132 and 152 may be a human user (e.g., member of the online social network), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 152.

The network 190 may be any network that enables communication between or among machines, databases 115, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

Any of the machines, databases 115, or devices 130, 150 described herein may be implemented in a computer modified (e.g., configured or programmed) by software (e.g., one or more software modules) to be a special-purpose computer to perform one or more of the functions described herein for that machine, database 115, or device 130, 150. For example, a computer system able to implement any one or more of the methodologies described herein is discussed below with respect to FIG. 6. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 115, or devices 130, 150 described herein may be combined into a single machine, database 115, or device 130, 150, and the functions described herein for any single machine, database 115, or device 130, 150 may be subdivided among multiple machines, databases 115, or devices 130, 150.

FIG. 2 is a block diagram illustrating components of an online social network 210, according to some example embodiments. The online social network 210 is an example of a network-based system 105 of FIG. 1. The online social network 210 can include a user interface 202, a message generator 204, a relevance score calculator 206, and a message interaction module 208, all configured to communicate with each other (e.g., via a bus, shared memory, or a switch). Additionally, the online social network 210 can communicate with the database 115 of FIG. 1, such as a database storing member data 218 and an event database 230.

The user interface 202 provides information or causes an interface to be rendered on a client device of the recipient. The user interface 202 presents the generated message to the recipient, and allows the recipient to interact with the received message. The interactions of the recipient are captured by the message interaction module 208. As later described, the interactions include the recipient opening the received message, clicking on a link contained in the received message, deleting the received message, flagging the received message as spam, replying to the received message, forwarding the received message, and so on.

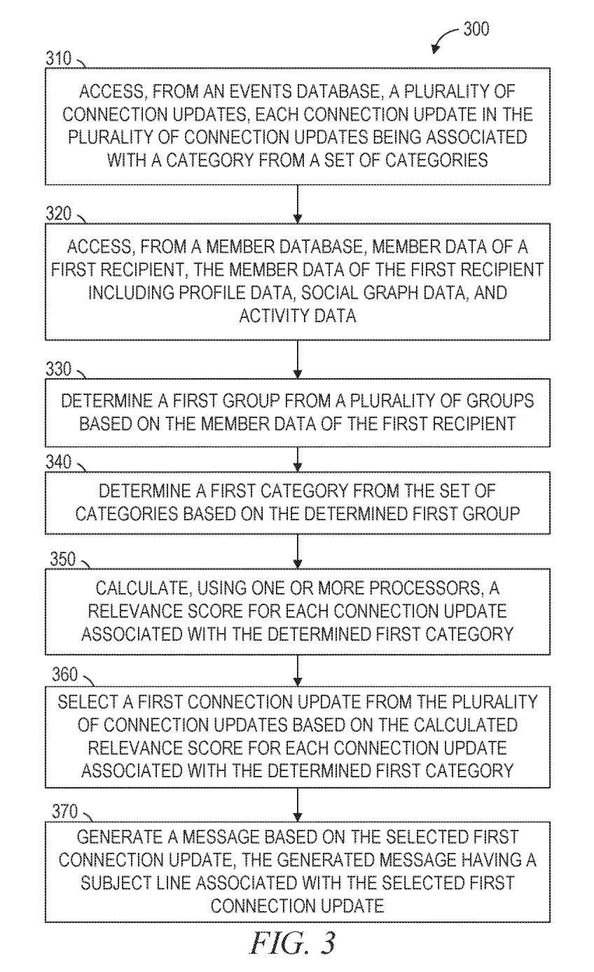

The message generator 204 generates a personalized message for each individual recipient. The message generator 204 selects a connection update based on a relevance score, and generates the personalized message for the recipient that includes the selected connection update. The relevance score for each connection update is calculated by the relevance score calculator 206. Method 300 in FIG. 3 describes an example of generating a personalized message for a recipient.

The relevance score is calculated based on the member data 218. Additionally, the connection update is derived based on updates to the member data 218. The member data 218 includes profile data 212, social graph data 214, and activity data 216 of a member. In some instances, the relevance score is calculated based on the member data 218 associated with the connection update (e.g., first member) that are in common with the member data 218 of the recipient. For example, the relevance score is calculated based on the number of first-degree connections that are in common between the first member that is associated with the connection update and the recipient. The social graph data 214 which is part of the member data 218 stores the first-degree connections of the first member and the recipient. Additionally, the relevance score can be calculated based on the profile data 212 (e.g., job title, industry, school information) that is in common between the first member and the recipient. Moreover, the relevance score can be calculated based on the activity data 216 that is in common between the first member and the recipient. Using the member data 218, the message generator 204 generates a message that is personalized to the recipient. In some instances, some of the processing of the data, such as calculating some or all parts of the relevance score, for generating the message can be performed by an offline data processor 220 on a periodic basis (e.g., nightly) in order to return results faster.

The profile data 212 include information available in a member's profile page, such as a member's personal and employment information. For instance, with many online social network services, when a user 132, 152 registers to become a member, the member is prompted to provide a variety of personal and employment information that may be displayed in a member's profile page. Such information is commonly referred to as profile data 212. The profile data 212 that is commonly requested and displayed as part of a member's profile includes the member's age, birthdate, gender, interests, contact information, residential address, home town and/or state, spouse's and/or family members' names, educational background (e.g., schools, majors, matriculation and/or graduation dates, etc.), employment history, job title, job industry, office location, skills, professional organizations, and so on. In some embodiments, the profile data 212 may include the various skills that each member has indicated he or she possesses. Additionally, the profile data 212 may include skills of a member that have been endorsed by another member.

With certain online social network services, such as professional network services, the profile data 212 can include employment information commonly included in a professional resume or curriculum vitae. The employment information can include a person's credentials (e.g., education), the company at which a person is employed, the location of the employer, an industry in which a person is employed, a job title or function, an employment history, skills possessed by a person, professional organizations of which a person is a member, a start date for a job, an end date for a job, and so on.

The event database 230 includes connection updates 235 associated with the recipient. The connection updates 235 associated with the profile data 212 reflect updates to the information in the member's profile page. For example, the member may have a new job, and therefore may update the employment information in the member's profile page. Other examples of connection updates include, but are not limited to, a job promotion, a job change, a certification completion, a degree completion, a location change, and a work anniversary.

In some instances, the member can upload documents, photos, links, videos, or presentations on the online social network 210. The connection updates 235 further include the recently uploaded documents, photos, links, videos, and presentations.

Additionally, the online social network 210 may provide its users 132, 152 with a mechanism for defining their relationships with other people. This digital representation of real-world relationships is frequently referred to as a social graph, which may be stored in the social graph data 214. The social graph data 214 of a member can include first-degree connections, second-degree connections, and so on.

In some instances, the social graph data 214 can be based on an entity's presence within the online social network service. For example, consistent with some embodiments, a social graph is implemented with a specialized graph data structure in which various entities (e.g., people, companies, schools, government institutions, non-profits, and other organizations) are represented as nodes connected by edges, where the edges have different types representing the various associations or relationships between the different entities.

The connection updates 235 associated with the social graph data 214 include a recently added first-degree connection of a member that is also a first-degree connection of the recipient, a post by the first-degree connection, a publication by an influencer, a publication by an organization, and so on. An influencer includes a member that is followed or liked by the recipient in the online social network 210.

In addition to hosting a vast amount of social graph data 214, the online social network 210 maintains activity data 216 of members. Typically, a user input is captured when a user 132, 152 interacts with a particular graphical user interface element, such as a button or a link, in the received message. For example, the recipient can open the received message, click on a link contained in the received message, delete the received message, flag the received message as spam, reply to the received message, forward the received message, and so on. The activity data 216 captures metrics associated with the recipient's interaction with the received message, such as a click-through-rate, a message open rate, and a reply rate. The click-through-rate is associated with the rate of the recipient clicking on a link in the received message. The message open rate is associated with the rate of the recipient opening the message. The reply rate is associated with the rate of the recipient replying to the message. Additionally, the activity data 216 can include a rate for the recipient deleting the received message, flagging the received message as spam, forwarding the received message, archiving the message, and any other interaction with the message.

Additionally, the user interaction of the recipient with the online social network 210 is captured and stored as the activity data 216. The activity data 216 includes members' interaction with the various applications, services, and content made available via the online social network 210, and the members' behavior (e.g., content viewed, links selected).

Furthermore, the online social network 210 can be configured to process data offline or periodically using the offline data processor 220. In some instances, some or all of the calculations by the relevance score calculator 206 can be performed by the offline data processor 220. According to another embodiment, the offline data processor 220 can include Hadoop servers that access the profile data 212 periodically (e.g., on a nightly basis) to calculate a relevance score for each connection update.

According to the another embodiment, some or all of the processing for generating the personalized message can take place offline to ensure reliable performance of the online social network 210. For example, the message generation for each recipient may be processed in the background or offline.

As will be further described with respect to FIGS. 3-6, the user interface 202, the message generator 204, the relevance score calculator 206, and the message interaction module 208 generate a personalized message for a recipient that includes relevant connection updates.

FIG. 3 is a flowchart illustrating operations of the network-based system 105 in performing a method 300 for generating a personalized message with relevant connection updates, according to some example embodiments. Operations in the method 300 may be performed by the online social network 210, the user interface 202, the message generator 204, the relevance score calculator 206, and the message interaction module 208 as described above with respect to FIG. 2. As shown in FIG. 3, the method 300 includes operations 310, 320, 330, 340, 350, 360, and 370.

At operation 310, the message generator 204 accesses a plurality of connection updates 235. For example, the connection updates 235 are stored in the event database 230. Each connection update in the plurality of connection updates 235 is associated with a category from a set of categories. In some instances, the connection updates 235 are updates associated with the first-degree connections of the recipient of the generated message. In some instances, the connection updates are updates that have occurred within a predetermined time frame (e.g., one day, one week) of the message being generated.

For example, the recipient can be the user 132 and the first-degree connection can be the user 152 of FIG. 1. The event database 230 can be the database 115 of FIG. 1. Continuing with this example, the user 132 (e.g., recipient), using the device 130, can access the database 115 using the network 190. Additionally, the user 132 can receive a generated message from the network-based system 105 (e.g., the message generator 204), using the network 190. The generated message can include a connection update associated with the user 152 (e.g., first-degree connection of the recipient). Additionally, the connection updates can be accessed using communication components (e.g., communication components 664 of FIG. 6) and stored in a memory (e.g., memory/storage 630 of FIG. 6).

The set of categories includes, but is not limited to, a job change of a first-degree connection, a profile page change of a first-degree connection, a publication posting by a first-degree connection, a work anniversary of a first-degree connection, a new skill of a first-degree connection, a job promotion of a first-degree connection, a certification completion of a first-degree connection, a degree completion of a first-degree connection, a location change of a first-degree connection, a new skill of a first-degree connection, a picture share, and so on. For example, the job change category includes connection updates 235 of the first-degree connections of the recipient that have recently (e.g., in the last week, in the last month) changed jobs. In another example, the location change category includes connection updates 235 of the first-degree connections of the recipient that have recently moved locations (e.g., cities). In some instances, a first-degree connection may have multiple connection updates, such as the connection changing jobs and moving to another city for the new job. The message generator 204 selects, at operation 360, the relevant connection update to include in the message based on the relevance score, which is calculated at operation 350, of each connection update. According to some embodiments, the message includes a subject line that is associated with the connection update that has the highest relevance score. Alternatively, the message includes a subject line that is associated with the connection update that has a relevance score that is above a predetermined threshold.

At operation 320, the message generator 204 accesses a member database storing member data 218 of a first recipient. The member data 218 of the first recipient includes profile data 212, social graph data 214, and activity data 216. The member database is similar to the database that stores the member data 218. In some instances, the member database is the database 115 of FIG. 1. The first recipient can be the user 132 of FIG. 1. The user 132 can access the database 115 using the network 190, to view an update of the user 152 (e.g., first-degree connection). Additionally, the member database can be accessed using communication components (e.g., communication components 664 of FIG. 6) and stored in a memory (e.g., memory/storage 630 of FIG. 6).

At operation 330, the message generator 204 determines a first group from a plurality of groups based on the member data of the first recipient. The first recipient is part of the first group. For example, the plurality of groups can be based on job titles (e.g., software engineers, recruiters, interns), and the first group can be a specific job title, such as a recruiter. In this example, the profile page of the first recipient can have “recruiter” listed as the job title, and the message generator 204 determines that the first recipient belongs to the recruiter group. A processor in the server machine 110 can perform the determination at operation 330. In some instances, part of the determination at operation 330 can be performed offline using the offline data processor 220.

In some instances, the first group is determined based on a job industry associated with the first recipient. Additionally, the first group can be determined based on a job title of the first recipient, a location of the first recipient, a previous employer of the first recipient, a school where the first recipient is currently enrolled, a school that the first recipient graduated from, seniority, job seeking propensity, email activity, last received email from the message generator, and so on.

At operation 340, the message generator 204 determines a first category from the set of categories based on the determined first group. The set of categories can include a job change of a connection, a location change of a connection, an educational change of a connection (e.g., the connection obtained a new degree or certification), a publication posted by a connection, a work anniversary of a connection, and so on. A processor in the server machine 110 can perform the determination at operation 340. In some instances, part of the determination at operation 340 can be performed offline using the offline data processor 220.

In some instances, based on the activity data 216 of the members in the first group, the message generator 204 can determine the first category from the set of categories. For example, based on metrics (e.g., click-through rate, message open rate) stored in the activity data 216, the message generator 204 determines that the job change category is relevant to the recruiter group. Therefore, in this example, when the first group is determined to be recruiters, the connection updates that are going to be sent to the recruiter group are associated with a job change of a first-degree connection of the recipient.

For example, the first category from the set of categories is determined based on the activity data of the determined first group, and the activity data includes a click-through rate, a message open rate, and so on.

At operation 350, the relevance score calculator 206 calculates a relevance score for each connection update associated with the determined first category. The relevance score calculator 206 can calculate the relevance score for each connection update using the member data 218 of the first recipient. For example, the relevance score for each connection update associated with the determined first category is calculated based on the activity data 216 of the first recipient. The activity data 216 can include a click-through rate for the first category, and the relevance score is calculated based on the click-through rate. Additionally, the activity data 216 can include a message open rate for the first category, and the relevance score is calculated based on the message open rate. As previously mentioned, the activity data 216 can include a rate associated with the first recipient flagging the message as spam, deleting the message, replying to the message, or forwarding the message, and the relevance score can be calculated based on these rates.

Continuing with the example above, a relevance score is calculated for each connection update associated with a job change of a first-degree connection of the first recipient. The relevance score is calculated based on the profile data 212, the social graph data 214, and the activity data 216. In some instances, the relevance score is calculated based on the number of common connections (e.g., first-degree, second degree) between the first-degree connection and the first recipient. Additionally, the relevance score can be calculated based on the profile data 212 (e.g., job title, industry, school information) that is in common between the first-degree connection and the first recipient. For example, the relevance score increases when the first-degree connection associated with the job change has more in common (e.g., based on similarity in the profile data 212, social graph data 214 and activity data 216) with the first recipient. A processor in the server machine 110 can perform the calculation at operation 350. In some instances, part of the calculation at operation 350 can be performed offline using the offline data processor 220.

The profile data 212 can be used to calculate the relevance score between the first recipient and the first-degree connection. For example, the relevance score increases when the first recipient and the first-degree connection have the same current or past employer. Additionally, the relevance score increases when the first recipient and the first-degree connection went to the same school, live in the same location, have a similar degree, or have a similar education.

Additionally, the social graph data 214 can be used to calculate the relevance score between the first recipient and the first-degree connection. For example, the relevance score increases when the first recipient and the first-degree connection have many connections in common (e.g., high connection density). The relevance score can also be based on the number of connections in common, the percentage of connections in common, and so on.

Moreover, the activity data 216 can be used to calculate the relevance score of each connection update in the first category. For example, the relevance score increases between the first recipient and the first-degree connection when the first recipient and the first-degree connection interact (e.g., message each other, recommend each other, endorse each other) with each other. The relevance score is also directly correlated to the click-through rate and the message open rate associated with the first category.

At operation 360, the message generator 204 selects a first connection update from the plurality of connection updates based on the calculated relevance score for each connection update associated with the determined first category. In some instances, the message generator 204 selects the connection updates with relevance scores that exceed a predetermined threshold. In some instances, when multiple connection updates are selected, the body of the email can contain the multiple connection updates, and the subject line of the email can be personalized based on the connection update with the highest relevance score. Alternatively, the message generator 204 selects the connection update with the highest relevance score of the connection updates associated with the first category. The connection update with the highest relevance score can be the update that is most relevant to the first recipient, and can cause the first recipient to open or interact with (e.g., click on a link in) the message. A processor in the server machine 110 can perform the selection at operation 360. In some instances, part of the selection at operation 360 can be performed offline using the offline data processor 220.

At operation 370, the message generator 204 generates a message based on the selected first connection update. In some instances, the message generator 204 generates a message using the first connection update selected at operation 360. In some instances, the generated message is an email having a subject line with the selected connection update. For example, the message generator 204 generates an email, and the subject line of the email includes information associated with the first connection update. Continuing with the example, the email can be sent to the first recipient, and the subject line of the email can state that a first-degree connection of the first recipient has changed jobs. A processor in the server machine 110 can be configured to generate the message.

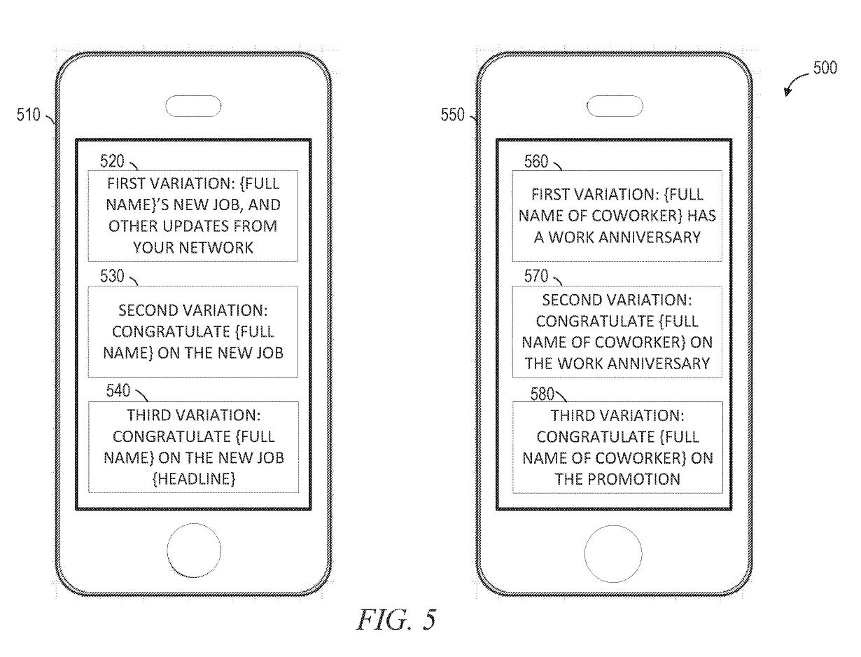

Additionally, at operation 370, the message generator 204 the generated message can have a subject line associated with the selected first connection update. For example, the subject line can be selected from a plurality of subject lines based on the profile data 212 of the first recipient. Additionally, the subject line can be selected from a plurality of subject lines based on the activity data 216 of the first recipient. Furthermore, the subject line can be selected from a plurality of subject lines based on social graph data 214 of the first recipient. FIG. 5 illustrates an example of the plurality of subject lines.

At operation 370, the subject line associated with the selected first connection update varies. In some instances, the first connection update can be the same, but the message generator can generate six different subject lines for the same connection update. As previously mentioned, the subject line is selected based on the member data 218 of the first recipient. Using machine learning techniques, the message generator can determine the subject line that is more likely to get the first recipient to open the message (e.g., email). As previously discussed, the machine learning techniques can use user feedback (e.g., click-through rate, open message rate) to determine and modify a coefficient (e.g., multiplier) associated with each input of calculating the relevance score. Inputs for calculating the relevance score include the number of connection in common between the recipient and the member associated with the connection update, a job title in common, a location in common, an industry in common, a school in common, and so on.

For example, when the first category is associated with a new job, the plurality of subject lines can include the following examples:
First Variation: {full name}'s new job, and other updates from your network;
Second Variation: Congratulate {full name} on the new job;
Third Variation: {full name} has a new job;
Fourth Variation: Congratulate {full name} on the new job {headline};
Fifth Variation: Check out {full name}'s new job {headline}; or
Sixth Variation: Check out {full name}'s new job.

Alternatively, when the first category is associated with a work anniversary, the plurality of subject lines can include the following examples:
{full name}'s work anniversary, and other updates from your network;
Congratulate {full name} on the work anniversary;
{full name} is celebrating a work anniversary;
Congratulate {full name}'s {year} year work anniversary at {company};
Checkout {full name}'s {year} year work anniversary at {company};
Checkout {full name}'s work anniversary at {company}; or
Checkout {full name}'s work anniversary.

Alternatively, when the first category is associated with a publication, the plurality of subject lines can include the following examples:
{full name}'s work anniversary, and other updates from your network;
{full name}'s recent post and other updates from your network;
Check out {full name}'s recent post;
{familiar name} shared: {article title}; or
See {full name} post ‘{article title}.

Alternatively, when the first category is associated with an endorsement, the plurality of subject lines can include the following examples:
{full name}'s new endorsement, and other updates from your network;
See {full name}'s new endorsement; or
{full name} was endorsed for {skill}.

In some instances, the message interaction module 208 causes a presentation, on a display of the device (e.g., device 130), of the generated message to the first recipient. The message interaction module 208 can cause the presentation on the display of the device 130 for the user 132 (e.g., the first recipient). In some instances, the publisher is a special-purpose graphical processing unit that generates the personalized message. Additionally, the message interaction module 208 can capture the interactions of the first recipient with the received generated message. For example, the message interaction module 208 increments a counter when the message is opened or when a link in the message is clicked on. The metrics (e.g., click-through rate, message open rate) are derived based on the counter and other information captured by the message interaction module 208.

In some instances, the method 300 further includes the user interface 202 receiving a user input. The user input can be received from the device 130. The user input can include opening the message, clicking on a link in the message, deleting the message, flagging the message as spam, replying to the message, forwarding the message, and so on. The message interaction module 208 and the user interface 202 allow the message generator 204 to capture activity data 216 associated with the first recipient. The activity data 216 is used to update the relevance score of subsequent connection updates.

For example, the method 300 can further include the message interaction module 208 receiving a user input indicative of opening the generated message. The user input can be received via the user interface 202. Additionally, the message interaction module 208 can update the message open rate based on the received user input. The message open rate is stored as activity data 216.

In some instances, the method 300 further includes a transmitter configured to transmit the generated message to the first recipient. Additionally, the message generator 204 can be further configured to cause a presentation, on a display of a device of the first recipient, of the generated message.

In some instances, the message generator 204 can push a notification (e.g., instant message in the online social network platform) to the members of the online social network. Furthermore, the method of pushing the notifications can be tailored to each recipient based on the activity interactions of the recipient.

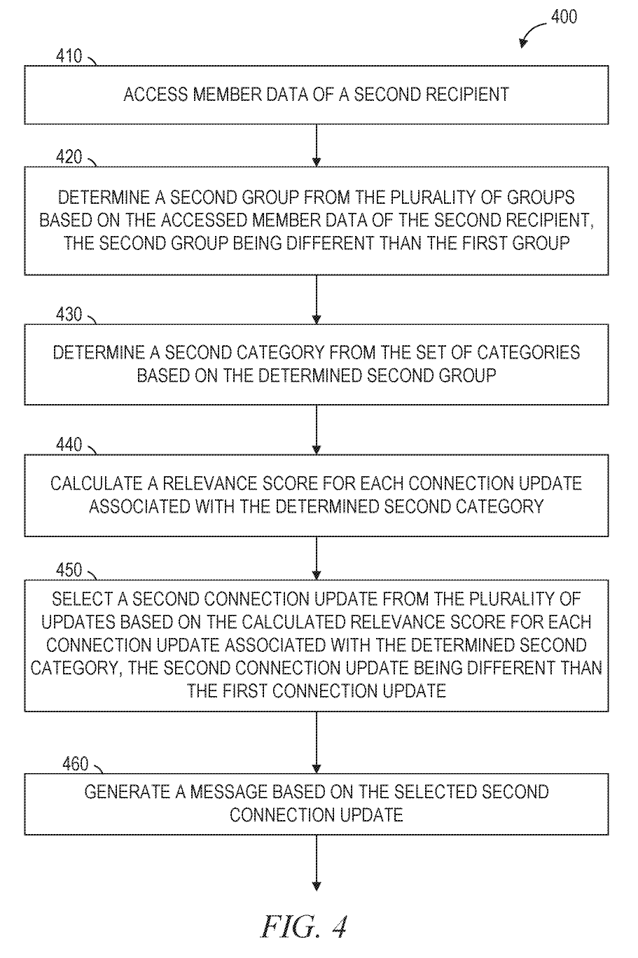

FIG. 4 is a flowchart illustrating operations of the online social network 210 in performing a method 400 for generating a second personalized message tailored to a second recipient, according to some example embodiments. Additionally, similar techniques to those described in the method 300 can be performed to determine the group associated with the second recipient and the category associated with the group, and to calculate the relevance scores. Operations in the method 400 may be performed by the online social network 210, using the message generator 204 and the relevance score calculator 206 described above with respect to FIG. 2. As shown in FIG. 4, the method 400 includes operations 410, 420, 430, 440, 450, and 460.

At operation 410, the message generator 204 accesses, from the member database, member data 218 of a second recipient. The member data includes profile data 212, social graph data 214, and activity data 216. Operation 320 of the method 300 describes techniques for accessing the member data 218.

At operation 420, the message generator 204 determines a second group from the plurality of groups based on the accessed member data of the second recipient. The second group can be different from the first group. For example, the first group associated with the first recipient is a recruiter group, and the second group associated with the second recipient is a software developer group. Operation 330 of method 300 describes techniques for determining the second group. As previously mentioned, the second group can be determined based on a job industry of the second recipient, a job title, a location, a previous employer, a school, and so on.

At operation 430, the message generator 204 determines a second category from the set of categories based on the determined second group. The set of categories can be the same set of categories described at operation 340 of the method 300. The set of categories can include a job change of a connection, a location change of a connection, an educational change of a connection (e.g., the connection obtained a new degree or certification), a publication posted by a connection, a work anniversary of a connection, and so on. In some instances, based on the activity data 216 of the members in the second group, the message generator 204 can determine the second category from the set of categories. For example, based on metrics (e.g., click-through rate, message open rate) stored in the activity data 216, the message generator 204 determines that a new posted publication is relevant to the software developer group. Continuing with the example from method 300, the connection updates that are going to be sent to the recruiter group are associated with a job change of a first-degree connection of the recipient, and the connection updates that are going to be sent to the software developers are associated with new posted publications.

Additionally, operation 340 of the method 300 describes techniques for determining the second category from the set of categories. Furthermore, the second category may be the same category as the first category. Alternatively, the second category may differ from the first category.

At operation 440, the relevance score calculator 206 calculates a relevance score for each connection update associated with the determined second category. Operation 350 of the method 300 describes techniques for calculating the relevance score for each connection update.

At operation 450, the message generator 204 selects a second connection update from the plurality of connection updates based on the calculated relevance score for each connection update associated with the determined second category. The second connection update is different from the first connection update since the second connection update is tailored to the second recipient. Operation 360 of the method 300 describes techniques for selecting the second connection update.

At operation 460, the message generator 204 generates a second message based on the selected second connection update. The second message can have a personalized subject line based on the selected second connection update. Operation 370 of the method 300 describes techniques for generating the second message.

In some instances, the message interaction module 208 causes a presentation, on a display of the device of the second recipient, of the generated second message. Additionally, the message interaction module 208 can capture the interactions of the second recipient with the second message. Moreover, the method 400 further includes a transmitter configured to transmit the generated message to the second recipient.

In some instances, the method 400 further includes the user interface 202 receiving a user input. The user input can be received from the device of the second recipient. The user input can include opening the message, clicking on a link in the message, deleting the message, flagging the message as spam, replying to the message, forwarding the message, and so on. The message interaction module 208 and the user interface 202 allow the message generator 204 to capture activity data 216 associated with the second recipient. The activity data 216 is used to update the relevance score of subsequent connection updates.

In some instances, the message generator 204 can change the variant of the message. For example, in a position change category, the message generator 204 can select from different variants of the same connection update. As later illustrated in FIG. 5, the message can have a first variant, such as “{full name}'s new job, and other updates from your network.” Alternatively, the message can be based on a second variant, such as “Congratulate {full name} on the new job,” or a third variant, such as “Congratulate {full name} on the new job {headline}.”

FIG. 5 is a user interface diagram 500 illustrating generated messages for a first recipient and a second recipient, according to some embodiments.

A first user interface 510 in FIG. 5 presents a generated message for a first recipient. The generated message is based on a first category (e.g., change in jobs) of a first-degree connection. For example, the first recipient is part of the recruiter group, and the message generator 204 determines that the preferred category for this group is a change in jobs. Additionally, the generated message is presented in three different variations such as a first variation 520, a second variation 530, and a third variation 540. The message generator 204 can select one of the variations based on the activity data 216 (e.g., click-through rate, message open rate) of the first recipient. For example, the generated message uses the first variation 520 when click-through rate is highest for messages with the first variation.

Furthermore, a second user interface 550 in FIG. 5 presents a generated message for a second recipient. The generated message is based on a second category (e.g., work anniversary, job promotion) of a coworker. For example, the second recipient is part of the software developer group, and the message generator 204 determines that the preferred category for this group is a work anniversary or job promotion of a coworker. Additionally, the generated message is presented in three different variations such as a first variation 560, a second variation 570, and a third variation 580. The message generator 204 can select one of the variations based on the activity data 216 (e.g., click-through rate, message open rate) of the second recipient. For example, the generated message uses the first variation 560 when click-through rate is highest for messages with the first variation.

According to various example embodiments, one or more of the methodologies described herein facilitate a better user experience in the online social network 210. Additionally, based on the database structure illustrated in FIG. 2, the message is generated in real time by using the offline data processor 220 for some calculations. For example, the online social network 210 can use the offline data processor 220, for the relevance score calculator 206 and the message generator 204, in such a way as to allow an efficient retrieval and processing of the information in order to calculate the relevance score, determine a category, determine a group, and generate a message based on a preferred variant in real time.

When these effects are considered in aggregate, one or more of the methodologies described herein may obviate a need for certain human efforts or resources that otherwise would be involved in generating a personalized message. Furthermore, computing resources used by one or more machines, databases 115, or devices 130, 150 (e.g., within the network environment 100) may similarly be reduced (e.g., by pre-determining relevance scores). Examples of such computing resources include processor cycles, network traffic, memory usage, data storage capacity, power consumption, and cooling capacity.

### Example Machine Architecture and Machine-Readable Medium

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 616 (e.g., software, a program, an application, an applet, an app, or other executable code) for causing the machine 600 to perform any one or more of the methodologies discussed herein may be executed. For example, the instructions 616 may cause the machine 600 (e.g., message generator 204 of FIG. 2) to execute the flow diagrams of FIGS. 3 and 4. Additionally, or alternatively, the instructions 616 may implement the relevance score calculator 206 of FIG. 2, and so forth. The instructions 616 transform the general, non-programmed machine 600 into a particular machine programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine 110 or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory/storage 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor 610, or any suitable combination thereof) may include, for example, a processor 612 and a processor 614 that may execute the instructions 616. The term “processor” is intended to include multi-core processors 610 that may comprise two or more independent processors 612, 614 (sometimes referred to as “cores”) that may execute the instructions 616 contemporaneously. Although FIG. 6 shows multiple processors 610, the machine 600 may include a single processor 612 with a single core, a single processor 612 with multiple cores (e.g., a multi-core processor), multiple processors 612, 614 with a single core, multiple processors 612, 614 with multiples cores, or any combination thereof.

The memory/storage 630 may include a memory 632, such as a main memory or other memory storage, and a storage unit 636, both accessible to the processors 610 such as via the bus 602. The storage unit 636 and memory 632 store the instructions 616 embodying any one or more of the methodologies or functions described herein. The instructions 616 may also reside, completely or partially, within the memory 632, within the storage unit 636, within at least one of the processors 610 (e.g., within the processor's cache memory), or any suitable combination thereof, during execution thereof by the machine 600. Accordingly, the memory 632, the storage unit 636, and the memory of the processors 610 are examples of machine-readable media.

As used herein, “machine-readable medium” means a device 130, 150 able to store the instructions 616 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 616. The term “machine-readable medium” shall also be taken to include any medium, or combination of multiple media, that is capable of storing instructions (e.g., instructions 616) for execution by a machine (e.g., machine 600), such that the instructions, when executed by one or more processors of the machine (e.g., processors 610), cause the machine to perform any one or more of the methodologies described herein. Accordingly, a “machine-readable medium” refers to a single storage apparatus or device 130, 150, as well as “cloud-based” storage systems or storage networks that include multiple storage apparatus or devices 130, 150. The term “machine-readable medium” excludes signals per se.

The I/O components 650 may include a wide variety of components to receive input, provide output, produce output, transmit information, exchange information, capture measurements, and so on. The specific I/O components 650 that are included in a particular machine 600 will depend on the type of machine 600. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion and the grouping is in no way limiting. In various example embodiments, the I/O components 650 may include output components 652 and input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 670 via a coupling 682 and a coupling 672 respectively. For example, the communication components 664 may include a network interface component or other suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a Universal Serial Bus (USB)).

Moreover, the communication components 664 may detect identifiers or include components operable to detect identifiers. For example, the communication components 664 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 616 may be transmitted or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 616 may be transmitted or received using a transmission medium via the coupling 672 (e.g., a peer-to-peer coupling) to the devices 670. The term “transmission medium” shall be taken to include any intangible medium that is capable of storing, encoding, or carrying the instructions 616 for execution by the machine 600, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 610 or a group of processors 610) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 610 or other programmable processor 610. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 610 configured by software to become a special-purpose processor, the general-purpose processor 610 may be configured as respectively different special-purpose processors (e.g., comprising different hardware modules) at different times. Software (e.g., a software module) may accordingly configure one or more processors 610, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 610 that are temporarily configured (e.g., by software) or permanently configured to perform the relevant operations. Whether temporarily or permanently configured, such processors 610 may constitute processor-implemented modules that operate to perform one or more operations or functions described herein. As used herein, “processor-implemented module” refers to a hardware module implemented using one or more processors 610.

Similarly, the methods described herein may be at least partially processor-implemented, a processor 610 being an example of hardware. For example, at least some of the operations of a method may be performed by one or more processors 610 or processor-implemented modules. As used herein, “processor-implemented module” refers to a hardware module in which the hardware includes one or more processors 610. Moreover, the one or more processors 610 may also operate to support performance of the relevant operations in a “cloud computing” environment or as a “software as a service” (SaaS). For example, at least some of the operations may be performed by a group of computers (as examples of machines 600 including processors 610), with these operations being accessible via a network 680 (e.g., the Internet) and via one or more appropriate interfaces (e.g., an application programming interface (API)).

The performance of certain operations may be distributed among the one or more processors 610, not only residing within a single machine 600, but deployed across a number of machines 600. In some example embodiments, the one or more processors 610 or processor-implemented modules may be located in a single geographic location (e.g., within a home environment, an office environment, or a server farm). In other example embodiments, the one or more processors 610 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 600. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 600 (e.g., a computer) that manipulates or transforms data represented as physical (e.g., electronic, magnetic, or optical) quantities within one or more memories 632 (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A system comprising:
an event database storing a plurality of connection updates, each connection update in the plurality of connection updates being associated with a category from a set of categories;
a member database storing member data of a first recipient, the member data of the first recipient including profile data, social graph data, and activity data; and
one or more processors configured to:
determine a first group from a plurality of groups based on the member data of the first recipient;
determine a first category from the set of categories based on the determined first group;
calculate a relevance score for each connection update associated with the determined first category;
select a first connection update from the plurality of connection updates based on the calculated relevance score for each connection update associated with the determined first category; and
generate a message based on the selected first connection update, the generated message having a subject line associated with the selected first connection update.

2. The system of claim 1, wherein the subject line is selected from a plurality of subject lines based on the profile data of the first recipient and the activity data of the first recipient.

3. The system of claim 1, wherein the relevance score for each connection update associated with the determined first category is calculated based on the member data of the first recipient.

4. The system of claim 3, wherein the activity data includes a click-through rate for the first category, and wherein the relevance score is calculated based on the click-through rate.

5. The system of claim 3, wherein the activity data includes a message open rate for the first category, and wherein the relevance score is calculated based on the message open rate.

6. The system of claim 5, wherein the one or more processors are further configured to:
receive a user input indicative of opening the generated message; and
update the message open rate based on the received user input.

7. The system of claim 1, wherein the first group is determined based on a job industry associated with the first recipient, or a job title of the first recipient.

8. The system of claim 1, wherein the first category from the set of categories is determined based on activity data of the determined first group, and wherein the activity data of the determined first group includes a click-through rate.

9. The system of claim 1, wherein the one or more processors are further configured to:
access member data of a second recipient;
determine a second group from the plurality of groups based on the accessed member data of the second recipient, the second group being different from the first group;
determine a second category from the set of categories based on the determined second group;
calculate a relevance score for each connection update associated with the determined second category;
select a second connection update from the plurality of connection updates based on the calculated relevance score for each connection update associated with the determined second category, the second connection update being different from the first connection update; and
generate a second message based on the selected second connection update.

10. The system of claim 1, further comprising:
a transmitter configured to transmit the generated message to the first recipient.

11. The system of claim 1, wherein the one or more processors are further configured to cause a presentation, on a display of a device of the first recipient, of the generated message.

12. The system of claim 1, wherein the set of categories includes a job change of a first-degree connection, a profile page change of a first-degree connection, and a publication posting by a first-degree connection.

13. The system of claim 1, wherein the set of categories includes a work anniversary of a first-degree connection, a new skill of a first-degree connection, and a new certification obtained by a first-degree connection.

14. The system of claim 1, wherein the connection updates are updates that have occurred within a week of the message being generated.

15. A method comprising:
accessing, from an event database, a plurality of connection updates, each connection update in the plurality of connection updates being associated with a category from a set of categories;
accessing, from a member database, member data of a first recipient, the member data of the first recipient including profile data, social graph data, and activity data;
determining a first group from a plurality of groups based on the member data of the first recipient;
determining a first category from the set of categories based on the determined first group;
calculating, using one or more processors, a relevance score for each connection update associated with the determined first category;
selecting a first connection update from the plurality of connection updates based on the calculated relevance score for each connection update associated with the determined first category; and
generating a message based on the selected first connection update, the generated message having a subject line associated with the selected first connection update.

16. The method of claim 15, wherein the subject line is selected from a plurality of subject lines based on the profile data of the first recipient and the activity data of the first recipient.

17. The method of claim 15, wherein the relevance score for each connection update associated with the determined first category is calculated based on the member data of the first recipient.

18. The method of claim 15, wherein the first category from the set of categories is determined based on activity data of the determined first group, and wherein the activity data of the determined first group includes a click-through rate.

19. The method of claim 15, further comprising:
accessing member data of a second recipient;
determining a second group from the plurality of groups based on the accessed member data of the second recipient, the second group being different from the first group;
determining a second category from the set of categories based on the determined second group;
calculating a relevance score for each connection update associated with the determined second category;
selecting a second connection update from the plurality of connection updates based on the calculated relevance score for each connection update associated with the determined second category, the second connection update being different from the first connection update; and
generating a second message based on the selected second connection update.

20. A non-transitory machine-readable storage medium comprising instructions that, when executed by one or more processors of a machine, cause the machine to perform operations comprising:
accessing, from an event database, a plurality of connection updates, each connection update in the plurality of connection updates being associated with a category from a set of categories;
accessing, from a member database, member data of a first recipient, the member data of the first recipient including profile data, social graph data, and activity data;
determining a first group from a plurality of groups based on the member data of the first recipient;
determining a first category from the set of categories based on the determined first group;
calculating a relevance score for each connection update associated with the determined first category;
selecting a first connection update from the plurality of connection updates based on the calculated relevance score for each connection update associated with the determined first category; and
generating a message based on the selected first connection update.
